(19) United States
(12) Patent Application Publication
(10) Pub. No.: US 2011/0186554 A1
(43) Pub. Date: Aug. 4, 2011

(54) WAFER DIVIDING METHOD USING CO2 LASER

(75) Inventors: Tasuku Koyanagi, Ota-Ku (JP); Hiroshi Morikazu, Ota-ku (JP)

(73) Assignee: DISCO CORPORATION, Tokyo (JP)

(21) Appl. No.: 13/004,171

(22) Filed: Jan. 11, 2011

(30) Foreign Application Priority Data
Feb. 3, 2010 (JP) 2010-022021

(51) Int. Cl. B23K 26/00

(52) U.S. Cl. 219/121.72

(57) ABSTRACT

A wafer dividing method for dividing a wafer into individual devices along a plurality of division lines formed on the front side of the wafer, the individual devices being respectively formed in a plurality of regions partitioned by the division lines. The wafer dividing method includes a division inducing region forming step of applying a laser beam having a transmission wavelength to the wafer along the division lines in the condition where the focal point of the laser beam is set inside the wafer, thereby forming a plurality of modified layers as division inducing regions inside the wafer along the division lines; and a dividing step of applying a CO₂ laser beam along the modified layers formed by the division inducing region forming step to thereby heat the wafer along the modified layers and next spraying a cooling medium to a heated area of the wafer heated by the CO₂ laser beam, thereby dividing the wafer into the individual devices.

### BACKGROUND OF THE INVENTION

1. Field of the Invention

The present invention relates to a method of dividing any one of various wafers into individual devices by applying a CO₂ laser beam to the wafer.

2. Description of the Related Art

Various devices such as ICs, LSIs, LEDs, and liquid crystal devices are formed on the front side of a silicon wafer, sapphire wafer, SiC wafer, glass wafer, etc. in a plurality of regions partitioned by a plurality of division lines. Any one of these various wafers is cut along the division lines to obtain the individual devices, which are used in various electronic equipment or the like. In dividing any one of these various wafers, it is known that a CO₂ laser beam is applied to an area to be divided to thereby heat this area and a cooling medium is next sprayed to this heated area heated by the CO₂ laser beam, thereby cutting this area of the wafer (see Japanese Patent Laid-Open No. Hei 10-323779 and Japanese Patent Laid-Open No. 2000-61677, for example).

### SUMMARY OF THE INVENTION

In the case that the wafer is formed from a noncrystalline structure such as a glass wafer, the wafer can be divided along the subject area heated by applying a CO₂ laser beam and next cooled by spraying a cooling medium. However, in the case that the wafer is formed from a monocrystalline structure such as a silicon wafer, sapphire wafer, and SiC wafer, there is a possibility that the wafer may be divided along an undesired area deviated from the subject area heated by the CO₂ laser beam because of the influence of a crystal orientation. When the wafer is divided along the undesired area deviated from the subject area heated by the CO₂ laser beam, there arises a problem such that the devices may be damaged or the quality of the devices may be degraded.

Further, the division lines are composed of division lines extending in a first direction and division lines extending in a second direction intersecting the first direction. Accordingly, in cutting the division lines extending in the second direction after cutting the division lines extending in the first direction, the division lines extending in the second direction become intermittent. Accordingly, there is a problem such that the wafer may not be completely divided along the division lines extending in the second direction.

It is therefore an object of the present invention to provide a wafer dividing method for dividing a wafer into individual devices along the subject area heated by applying a CO₂ laser beam and next cooled by spraying a cooling medium irrespective of the kind of the wafer and whether or not the division lines extending in the first direction have already been cut.

In accordance with an aspect of the present invention, there is provided a wafer dividing method for dividing a wafer into individual devices along a plurality of crossing division lines formed on the front side of the wafer, the individual devices being respectively formed in a plurality of regions partitioned by the division lines, the wafer dividing method including a division inducing means forming step of applying a laser beam having a transmission wavelength to the wafer along the division lines in the condition where the focal point of the laser beam is set inside the wafer, thereby forming a plurality of modified layers as division inducing means inside the wafer along the division lines; and a dividing step of applying a CO₂ laser beam along the modified layers formed by the division inducing means forming step to thereby heat the wafer along the modified layers and next spraying a cooling medium to a heated area of the wafer heated by the CO₂ laser beam, thereby dividing the wafer into the individual devices.

In accordance with another aspect of the present invention, there is provided a wafer dividing method for dividing a wafer into individual devices along a plurality of crossing division lines formed on the front side of the wafer, the individual devices being respectively formed in a plurality of regions partitioned by the division lines, the wafer dividing method including a division inducing means forming step of applying a laser beam having an absorption wavelength to the wafer along the division lines, thereby forming a plurality of ablation grooves as division inducing means on the front side of the wafer along the division lines; and a dividing step of applying a CO₂ laser beam along the ablation grooves formed by the division inducing means forming step to thereby heat the wafer along the ablation grooves and next spraying a cooling medium to a heated area of the wafer heated by the CO₂ laser beam, thereby dividing the wafer into the individual devices.

According to the present invention, the division inducing means is formed in the division inducing means forming step. Thereafter, in the dividing step, the CO₂ laser beam is applied along the division inducing means to heat the wafer, and the cooling medium is next sprayed to the heated area of the wafer heated by the CO₂ laser beam, thereby dividing the wafer along the division lines. Accordingly, even when the wafer is formed from a monocrystalline structure, the wafer can be accurately divided along the division lines without the influence of a crystal orientation, so that there is no possibility of damage to the devices and a degradation in their quality.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser processing apparatus used in performing a wafer dividing method according to a preferred embodiment of the present invention;

FIG. 2 is a perspective view showing a wafer formed from a monocrystalline structure and holding means for holding the wafer;

FIG. 3 is a perspective view showing a division inducing means forming step for the wafer shown in FIG. 2;

FIG. 4 is a perspective view showing a dividing step for the wafer shown in FIG. 2;

FIG. 5 is a perspective view showing a wafer formed from a noncrystalline structure and holding means for holding the wafer;

FIG. 6 is a perspective view showing a division inducing means forming step for the wafer shown in FIG. 5; and

FIG. 7 is a perspective view showing a dividing step for the wafer shown in FIG. 5.

### DETAILED DESCRIPTION OF THE PREFERRED EMBODIMENTS

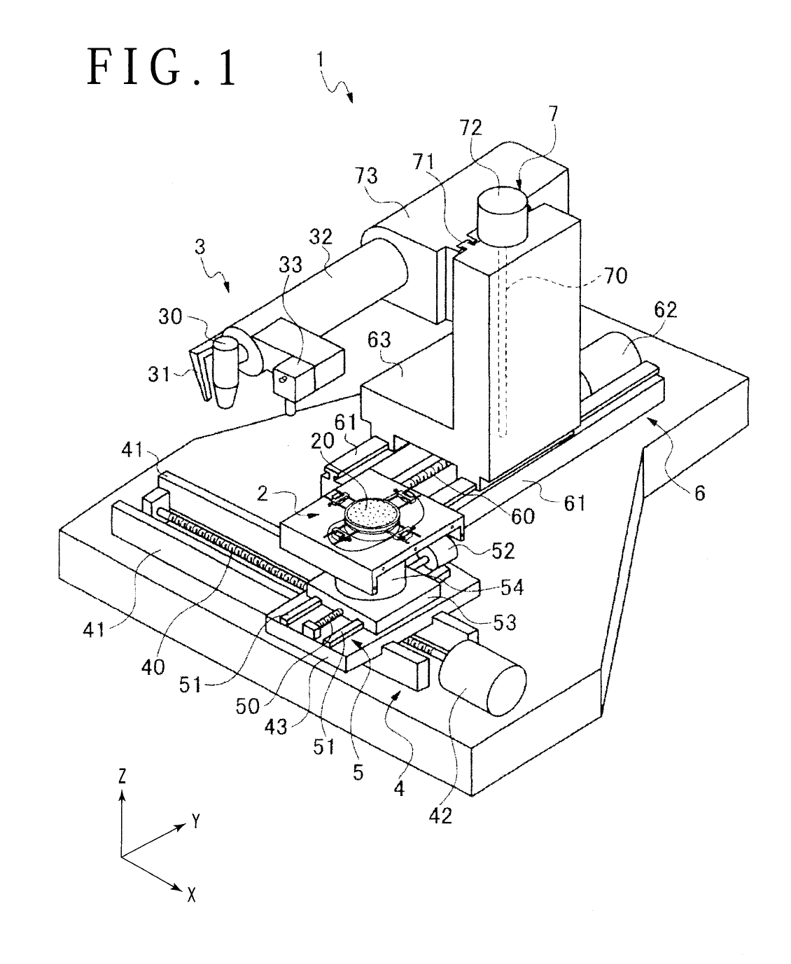

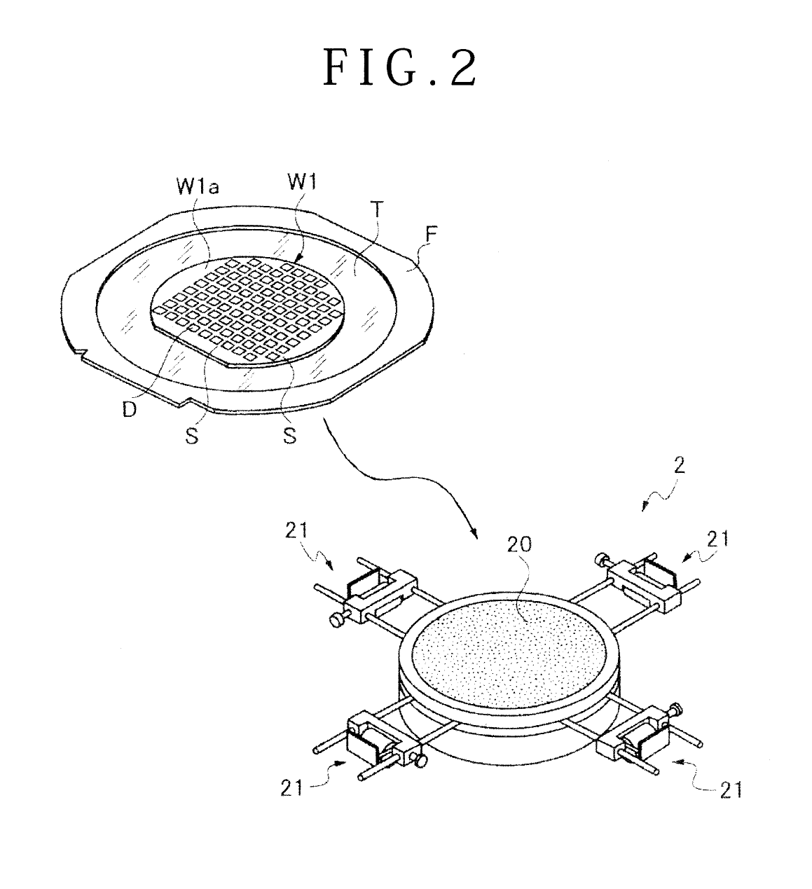

A laser processing apparatus 1 shown in FIG. 1 includes holding means 2 for holding a wafer and processing means 3 having a function of applying a laser beam from a laser beam applying head 30 to the wafer and a function of spraying a cooling medium from a cooling medium spraying nozzle 31 to the wafer. As shown in FIG. 2, a wafer W1 as an object to be divided is supported through an adhesive tape T to a ringlike frame F. In correspondence therewith, the holding means 2 includes a chuck table 20 for holding the wafer W1 under suction and a plurality of clamps 21 for fixing the frame F.

As shown in FIG. 1, the holding means 2 is supported so as to be movable in the X direction by X-direction moving means 4 and also supported so as to be movable in the Y direction by first Y-direction moving means 5. The processing means 3 is supported so as to be movable in the Y direction by second Y-direction moving means 6 and also supported so as to be movable in the Z direction by Z-direction moving means 7. The X-direction moving means 4 includes a ball screw 40 having an axis extending in the X direction, a pair of guide rails 41 extending parallel to the ball screw 40, a motor 42 connected to one end of the ball screw 40, and a slide member 43 having an internal nut (not shown) threadedly engaged with the ball screw 40 and a lower portion kept in sliding contact with the guide rails 41. When the motor 42 is operated to rotate the ball screw 40, the slide member 43 is slid on the guide rails 41 in the X direction.

The first Y-direction moving means 5 for moving the holding means 2 in the Y direction is provided on the slide member 43. The first Y-direction moving means 5 includes a ball screw 50 having an axis extending in the Y direction, a pair of guide rails 51 extending parallel to the ball screw 50, a pulse motor 52 connected to one end of the ball screw 50, and a moving base 53 having an internal nut (not shown) threadedly engaged with the ball screw 50 and a lower portion kept in sliding contact with the guide rails 51. When the pulse motor 52 is operated to rotate the ball screw 50, the moving base 53 is slid on the guide rails 51 in the Y direction. Rotational driving means 54 including a pulse motor for rotating the holding means 2 is provided on the moving base 53.

The second Y-direction moving means 6 includes a ball screw 60 having an axis extending in the Y direction, a pair of guide rails 61 extending parallel to the ball screw 60, a pulse motor 62 connected to one end of the ball screw 60, and a slide member 63 having an internal nut (not shown) threadedly engaged with the ball screw 60 and a lower portion kept in sliding contact with the guide rails 61. When the pulse motor 62 is operated to rotate the ball screw 60, the slide member 63 is slid on the guide rails 61 in the Y direction, and the processing means 3 is accordingly moved in the Y direction.

The Z-direction moving means 7 includes a ball screw 70 having an axis extending in the Z direction, a pair of guide rails 71 extending parallel to the ball screw 70, a pulse motor 72 connected to one end of the ball screw 70, and a vertical moving member 73 having an internal nut (not shown) threadedly engaged with the ball screw 70 and a side portion kept in sliding contact with the guide rails 71. The processing means 3 is supported by the vertical moving member 73. When the pulse motor 72 is operated to rotate the ball screw 70, the vertical moving member 73 is moved in the Z direction as being guided by the guide rails 71, and the processing means 3 is accordingly moved in the Z direction.

The processing means 3 includes a housing 32, the laser beam applying head 30 fixed to the front end of the housing 32 for applying a laser beam downwardly, and the cooling medium spraying nozzle 31 fixed to the front end of the housing 32 adjacent to the laser beam applying head 30 for spraying a cooling medium downwardly. Further, detecting means 33 for imaging and detecting an area to be divided is fixed to a side portion of the housing 32 in the vicinity of the laser beam applying head 30.

A method of dividing the wafer W1 shown in FIG. 2 will now be described. The wafer W1 is formed from a monocrystalline structure of sapphire, SiC, Si, etc. The monocrystalline structure has a front side W1a, and a plurality of devices D are formed on the front side W1a so as to be partitioned by a plurality of crossing division lines (streets) S. The wafer W1 is held on the chuck table 20 under suction, and the frame F supporting the wafer W1 through the adhesive tape T is fixed by the clamps 21. The holding means 2 holding the wafer W1 is moved in the X direction by the X-direction moving means 4 shown in FIG. 1 so that the wafer W1 is positioned directly below the detecting means 33. A predetermined one of the division lines S as an area to be divided is detected by the detecting means 33 to align this detected division line S and the laser beam applying head 30 in the Y direction.

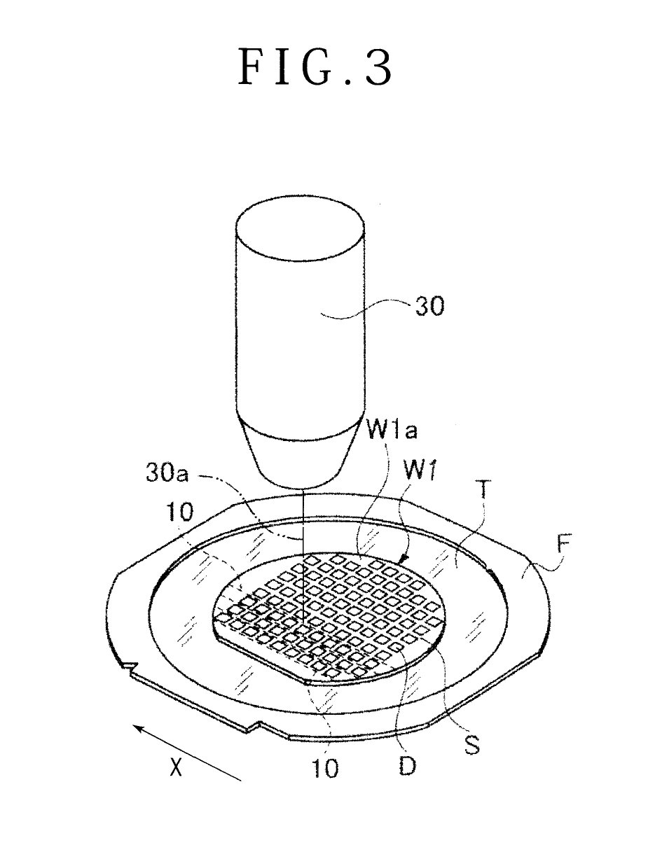

As shown in FIG. 3, a laser beam 30a is applied from the laser beam applying head 30 to the detected division line S as moving the holding means 2 in the X direction at a feed speed of 100 mm/sec, for example. The laser beam 30a is a YAG laser beam having a transmission wavelength of 1064 nm to the wafer W1. The power of the laser beam 30a is set to 3 W, for example. The laser beam 30a is applied to the wafer W1 in the condition where the focal point of the laser beam 30a is set inside the wafer W1, thereby forming a modified layer 10 inside the wafer W1 along the detected division line S. The modified layer 10 means a region different from its ambient region in density, refractive index, mechanical strength, or any other physical properties.

After forming the modified layer 10 along the detected division line S as mentioned above, the processing means 3 is moved in the Y direction by the pitch of the division lines S extending in a first direction, and the above laser processing is similarly performed to form another modified layer 10 along the present division line S. Thereafter, the above laser processing is similarly performed along the other division lines S extending in the first direction to form modified layers 10 along these division lines S. Thereafter, the holding means 2 is rotated 90°, and the above laser processing is similarly performed along the remaining division lines S extending in a second direction perpendicular to the first direction to thereby form modified layers 10 along these division lines S extending in the second direction. These crossing modified layers 10 along the crossing division lines S extending in the first and second directions function as division inducing means in a subsequent dividing step. That is, the step of forming the modified layers 10 means a division inducing means forming step.

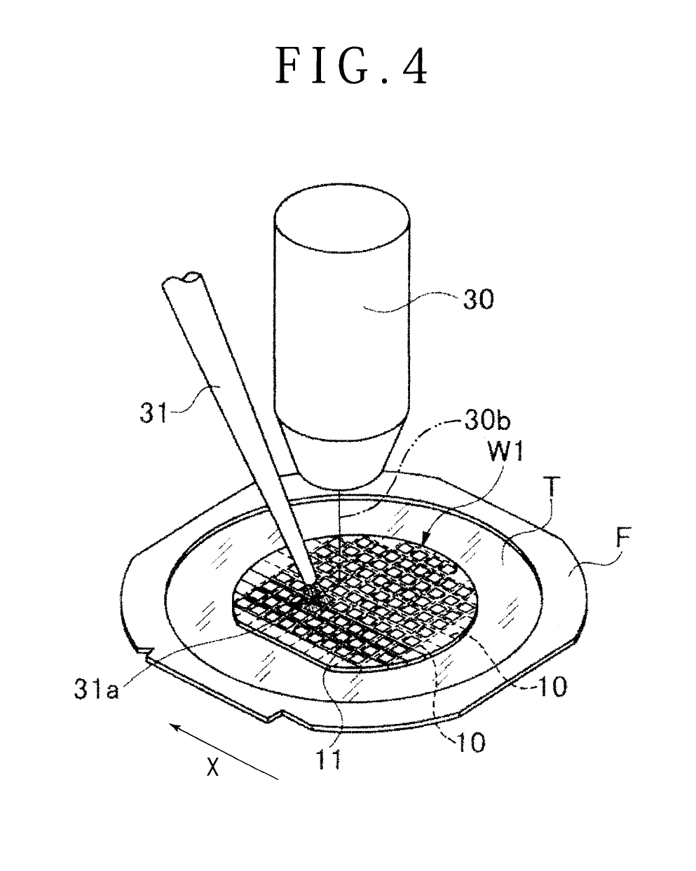

As shown in FIG. 4, a CO₂ laser beam 30b is applied from the laser beam applying head 30 to the wafer W1 along the division line S detected by the detecting means 33 where the modified layer 10 has been formed and a cooling medium 31a is also sprayed from the cooling medium spraying nozzle 31 to the wafer W1 along the detected division line S as moving the holding means 2 in the X direction at a feed speed of 200 mm/sec, for example. The wavelength of the CO₂ laser beam 30b is set to 10.6 μm, and the power of the CO₂ laser beam 30b is set to 35 W, for example. The cooling medium 31a is a mist at 20° C. and it is sprayed at a rate of 2 ml/sec, for example. By applying the CO₂ laser beam 30b and spraying the cooling medium 31a, the modified layer 10 is subjected to rapid heating by the application of the CO₂ laser beam 30b and rapid cooling by the spraying of the cooling medium 31a, thereby producing a high thermal stress in the modified layer 10. As a result, division of the wafer W1 is induced by the modified layer 10 to form a cut groove 11 along this division line S.

After forming the cut groove 11 along the detected division line S by applying the CO₂ laser beam 30b and spraying the cooling medium 31a as mentioned above, the processing means 3 is moved in the Y direction by the pitch of the division lines S extending in the first direction, and the above processing using the CO₂ laser beam 30b and the cooling medium 31a is similarly performed to form another cut groove 11 along the present division line S. Thereafter, the above processing using the CO₂ laser beam 30b and the cooling medium 31a is similarly performed along the other division lines S extending in the first direction. Thereafter, the holding means 2 is rotated 90°, and the above processing using the CO₂ laser beam 30b and the cooling medium 31a is similarly performed along the remaining division lines S extending in the second direction perpendicular to the first direction to thereby form cut grooves 11 along these division lines S extending in the second direction. As a result, the wafer W1 is divided along all of the division lines S to obtain the individual devices D (dividing step).

As described above, in the division inducing means forming step, the modified layers 10 for inducing the CO₂ laser beam irradiated in the dividing step are preliminarily formed. Accordingly, even when the wafer W1 is formed from a monocrystalline structure, the wafer W1 can be accurately divided along the division lines S without the influence of a crystal orientation, so that there is no possibility of damage to the devices D and a degradation in their quality. Further, in cutting the division lines S extending in the second direction perpendicular to the previously cut division lines S extending in the first direction, the direction of division is induced by the modified layers 10. Accordingly, the division lines S extending in the second direction can be accurately cut without the influence of the previously cut division lines S extending in the first direction.

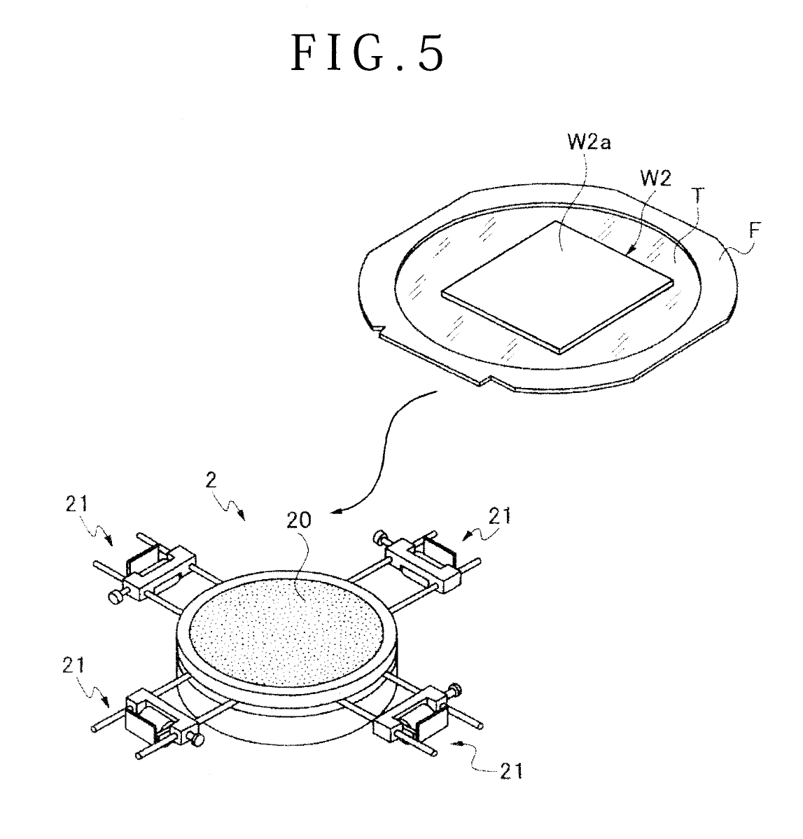

FIG. 5 shows a wafer W2 formed from a noncrystalline structure such as a glass wafer. Also in dividing the wafer W2, the wafer W2 is attached to an adhesive tape T supported to a ringlike frame F as shown in FIG. 5. A method of dividing the wafer W2 by using the laser processing apparatus 1 shown in FIG. 1 will now be described. The wafer W2 is held on the chuck table 20 under suction, and the frame F is fixed by the clamps 21. The holding means 2 holding the wafer W2 is moved in the X direction by the X-direction moving means 4 shown in FIG. 1 so that the wafer W2 is positioned directly below the detecting means 33. Thereafter, a predetermined one of the division lines S as an area to be divided is detected by the detecting means 33 to align this detected division line S and the laser beam applying head 30 in the Y direction.

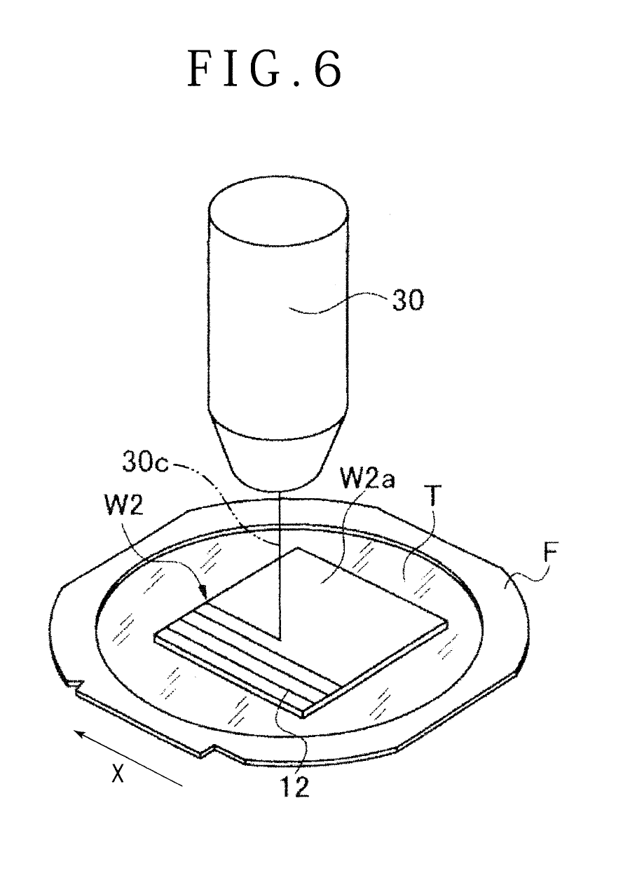

As shown in FIG. 6, a laser beam 30c is applied from the laser beam applying head 30 to the detected division line S as moving the holding means 2 in the X direction at a feed speed of 100 mm/sec, for example. The laser beam 30c is a laser beam having an absorption wavelength of 355 nm to the wafer W2, for example. The power of the laser beam 30c is set to 0.2 W, for example. The wafer W2 has a front side W2a, and the laser beam 30c is applied to the wafer W2 along the detected division line S in the condition where the focal point of the laser beam 30c is set on the front side W2a, thereby forming an ablation groove 12 on the front side W2a along the detected division line S.

After forming the ablation groove 12 along the detected division line S as mentioned above, the processing means 3 is moved in the Y direction by the pitch of the division lines S extending in a first direction, and the above laser processing is similarly performed to form another ablation groove 12 along the present division line S. Thereafter, the above laser processing is similarly performed along the other division lines S extending in the first direction to form ablation grooves 12 along these division lines S. Thereafter, the holding means 2 is rotated 90°, and the above laser processing is similarly performed along the remaining division lines S extending in a second direction perpendicular to the first direction to thereby form ablation grooves 12 along these division lines S extending in the second direction. These crossing ablation grooves 12 along the crossing division lines S extending in the first and second directions function as division including means in a subsequent dividing step. That is, the step of forming the ablation grooves 12 means a division inducing means forming step.

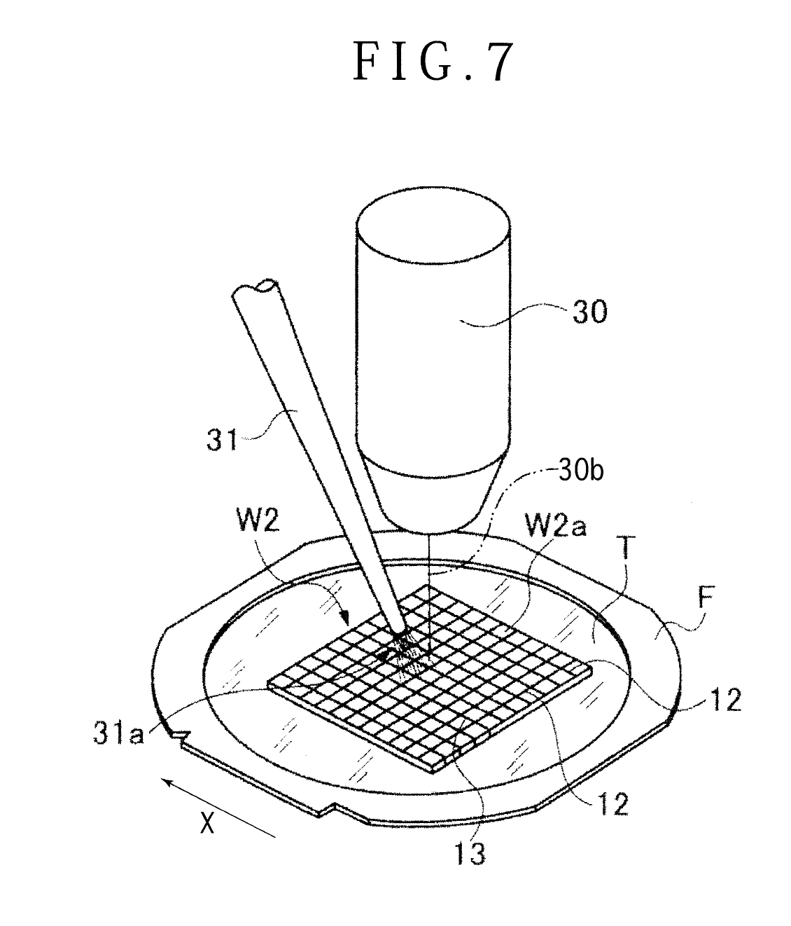

As shown in FIG. 7, a CO₂ laser beam 30b is applied from the laser beam applying head 30 to the ablation groove 12 and a cooling medium 31a is also sprayed from the cooling medium spraying nozzle 31 to the ablation groove 12 as moving the holding means 2 in the X direction at a feed speed of 200 mm/sec, for example. The wavelength of the CO₂ laser beam 30b is set to 10.6 μm, and the power of the CO₂ laser beam 30b is set to 35 W, for example. The cooling medium 31a is a mist at 20° C. and it is sprayed at a rate of 2 ml/sec, for example. By applying the CO₂ laser beam 30b and spraying the cooling medium 31a, division of the wafer W2 is induced by the ablation groove 12 to form a cut groove 13 along this division line S.

After forming the cut groove 13 along the detected division line S by applying the CO₂ laser beam 30b and spraying the cooling medium 31a as mentioned above, the processing means 3 is moved in the Y direction by the pitch of the division lines S extending in the first direction, and the above processing using the CO₂ laser beam 30b and the cooling medium 31a is similarly performed to form another cut groove 13 along the present division line S. Thereafter, the above processing using the CO₂ laser beam 30b and the cooling medium 31a is similarly performed along the other division lines S extending in the first direction to form cut grooves 13 along these division lines S. Thereafter, the holding means 2 is rotated 90°, and the above processing using the CO₂ laser beam 30b and the cooling medium 31a is similarly performed along the remaining division lines S extending in the second direction perpendicular to the first direction to thereby form cut grooves 13 along these division lines S extending in the second direction. As a result, the wafer W2 is divided along all of the division lines S to obtain the individual devices D (dividing step).

As described above, also in the case of dividing the wafer W2 formed from a noncrystalline structure such as a glass wafer along the division lines S, the wafer W2 can be accurately divided by preliminarily forming the ablation grooves 12 on the front side of the wafer W2 along the division lines S. Further, in cutting the division lines S extending in the second direction perpendicular to the previously cut division lines S extending in the first direction, the direction of division is induced by the ablation grooves 12. Accordingly, the division lines S extending in the second direction can be accurately cut without the influence of the previously cut division lines S extending in the first direction.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A wafer dividing method for dividing a wafer into individual devices along a plurality of crossing division lines formed on the front side of said wafer, said individual devices being respectively formed in a plurality of regions partitioned by said division lines, said wafer dividing method comprising:
a division inducing means forming step of applying a laser beam having a transmission wavelength to said wafer along said division lines in the condition where the focal point of said laser beam is set inside said wafer, thereby forming a plurality of modified layers as division inducing means inside said wafer along said division lines; and
a dividing step of applying a CO₂ laser beam along said modified layers formed by said division inducing means forming step to thereby heat said wafer along said modified layers and next spraying a cooling medium to a heated area of said wafer heated by said CO₂ laser beam, thereby dividing said wafer into said individual devices.

2. A wafer dividing method for dividing a wafer into individual devices along a plurality of crossing division lines formed on the front side of said wafer, said individual devices being respectively formed in a plurality of regions partitioned by said division lines, said wafer dividing method comprising:
a division inducing means forming step of applying a laser beam having an absorption wavelength to said wafer along said division lines, thereby forming a plurality of ablation grooves as division inducing means on the front side of said wafer along said division lines; and
a dividing step of applying a CO₂ laser beam along said ablation grooves formed by said division inducing means forming step to thereby heat said wafer along said ablation grooves and next spraying a cooling medium to a heated area of said wafer heated by said CO₂ laser beam, thereby dividing said wafer into said individual devices.
